(19) United States
(12) Patent Application Publication
(10) Pub. No.: US 2014/0304048 A1
(43) Pub. Date: Oct. 9, 2014

(54) DESCENDING-PRICE AUCTION METHOD WITH PARTICIPATING FEE

(71) Applicant: Jonathan Asselin-Normand, St-Paul (CA)

(72) Inventor: Jonathan Asselin-Normand, St-Paul (CA)

(73) Assignee: INNOV AUCTIONS INC., Wilmington, DE (US)

(21) Appl. No.: 14/229,934

(22) Filed: Mar. 30, 2014

Related U.S. Application Data
(60) Provisional application No. 61/806,856, filed on Mar. 30, 2013.

(51) Int. Cl. G06Q 30/08; G06Q 30/02

(52) U.S. Cl. CPC G06Q 30/08; G06Q 30/0222
USPC 705/14.22

(57) ABSTRACT

A system and method is provided for a descending-price auction with participation fee. The present invention starts with the buying of participations by prospective buyers. The auction starts near the retail price and time duration is announced at the start of the auction within which each participant can bid for the asset for sale. The prospective buyers use their bought participations for bidding. The price is decreased by a predefined amount till the price reaches zero currency units after which it stays at zero and the time duration is reset. The whole process of the auction is repeated till the end of auction time and the last participant will be deemed the final buyer for the last low price. Other participants can also be compensated with other benefits according to the level of their participation in the auction.

### CROSS REFERENCE TO RELATED APPLICATIONS

The present application claims the benefit under 35 U.S.C. §119(e) of U.S. Provisional Patent Application Ser. No. 61/806,856 filed on Mar. 30, 2013, and entitled “DESCENDING-PRICE AUCTION METHOD WITH PARTICIPATING FEE” which is incorporated herein by reference for all purposes.

### FIELD OF INVENTION

The present invention relates generally to an electronic commerce method and system and, more particularly, to an auction system in which the price decreases as interested buyers bid.

### BACKGROUND OF INVENTION

Traditional auction methods are good for selling and buying items in the physical presence of interested buyers, starting at a pre-defined price and then raising or decreasing the price gradually. The seller puts an item up for sale at a pre-defined price and then the interested buyers bid incremental offers till there is no additional offer or the seller decreases the price till there is a prospective buyer willing to accept the offer. Online auctions have revolutionized auction sales in that the buyers can be anywhere in the world, participating in the auction through an internet network. The auction sales are not limited to the above cited examples but can be organized through various formats which can be made interesting by using different auction methodologies such as the ascending price auction, also known as an English auction, and descending price auction, also known as a Dutch auction.

The English auction or ascending price auction is the well-known auction methodology where the price of the item increases with every bid. The auction is deemed complete when the auctioneer so announces by the fall of the hammer or in other customary manner after a reasonable time without any new offer. Since the arrival of online auctions, an auction time deadline is often set, wherein the most crucial time for bidding is in the last minutes. The Dutch auction starts at retail or near retail price and the seller gradually decreases the price as the time goes on. The auction is deemed complete when an interested buyer agrees to pay the current price to buy the item. The above explained traditional auction methods are simple and limited in their methodologies and policies. Various innovative auction methods have also developed over the years, especially since online auctions have become popular. Auctions are one of the most appealing selling models for buyers as they can offer bigger savings. However, the traditional auction methods have become well-known, popular and overused since the advent of online auctions, making savings limited.

Thus, there is a need of an auction system and methodology which could give the opportunity to prospective buyers to realize savings at all times during the auction, even if there are already many bids in the auction (English auction) and without limitation to only one bidder (Dutch auction). The auction will start near the retail price, with a reserved guaranteed discount, and then the price will decrease gradually. The gradual decrease in price will be funded by a participating fee that must be paid for every bid on the article. Therefore, the final buyer of the auction will receive a big discount and other bidders will receive compensation according to the number of paid bids they have used in the auction.

### SUMMARY OF INVENTION

According to an embodiment of the present invention, there is provided a descending-price auction with participating fee method and system in which the price of the item for sale, such as but not limited to a tangible or intangible asset offered for auction, is decreased by a pre-defined amount on the basis of a used bid (also referred as “participating fee” or “participation right”) by an interested buyer. Buyers can acquire participations by different purchase means, such as but not limited to purchasing them as packages or subscriptions. The asset for sale is offered at an initial price which is near or similar to its retail price and then the initially offered price is decreased by a pre-defined amount on the basis of a used participation by a bidder. The price will be reduced for every new bid used till it reaches zero and will stay at zero for every new bid used after that. The last bidder after which there is no bid purchased within the bid time interval will be deemed as the buyer and the asset will be offered for free (the buyer will have given the consideration of the participating fee) once the price reaches zero within the auction time.

In another embodiment of the present invention, a network based system is established for managing the auction. The system comprises a server, a buyer communication device, a seller communication device and a communication network. The auction instructions are stored in the server memory and are executed by the server processor. The system receives the auction instructions and parameters from the seller, which pre-defines the auction terms before start of the auction, or the system can fix these terms by itself. The system then announces the auction over the network and displays the auction information and auction parameters on the buyer communication device. The system starts the auction within the pre-announced time interval, decreases the price on the basis of used bids in the auction, and resets the auction time for the next bidding process as per the auction parameters defined. The system continues to decrease the price till it reaches zero and keeps the price at zero for consecutive bid participations offered if another interested buyer uses a participation right. The system will offer the asset for sale for free if the price reaches zero during the auction process.

An object of the present invention is to provide a descending-price auction method and system with participating fee in which, with every participation used by a bidder, the price of the asset will be decreased by a predefined amount, as defined by the auction provider or by the seller.

An additional object of the present invention is to provide a descending-price auction method and system with participating fee with a feature in which, with every new participation used by a prospective buyer, the predefined auction time will be reset.

A further object of the present invention is to provide a descending-price auction method and system with participating fee in which the discount amount for every asset offered for auction is reserved in order to ensure minimum savings to the buyer of the auction if the auction ends prematurely.

A contributory object of the present invention is to provide a descending-price auction method and system with participating fee in which, if the price is reduced to zero, the seller will provide the asset for free to the buyer.

An added object of the present invention is to provide a descending-price auction method and system with participating fee that compensates participants with other benefits such as but not limited to discounts on their next purchase of participation rights, a discount on the asset offered for sale, or the like which are predefined by the auction provider or by the seller.

Another object of the present invention is to provide a descending-price auction method and system with participating fee that provides the provider or seller with access to buyer information such as but not limited to number of actual prospective buyers, offered opportunities to purchase, buyer history or the like.

A further object of the present invention is to provide a descending-price auction method and system with participating fee in which the maximum number of participants is defined by the auction provider or by the seller, to ensure fair opportunities for the prospective buyers.

Another object of the present invention is to provide a descending-price auction method and system with participating fee in which the source of revenue is the participation fees and not the final price of the asset offered for sale.

An additional object of the present invention is to let the last participant of the auction obtain the asset for sale at the last price of the auction after the participation of this last participant, which last price is paid to the seller.

### BRIEF DESCRIPTION OF THE DRAWINGS

The invention is described herein by way of example only. In the drawings, like reference numbers may indicate identical or functionally similar elements. For a more complete understanding of this disclosure and its features, reference is now made to the following description, taken in conjunction with the accompanying drawings, in which:

FIG. 1 illustrates a system for conducting a descending-price auction with participating fee in accordance with one embodiment of the present invention; and

FIG. 2 is a flow diagram illustrating a method of conducting a descending-price auction with participating fee in accordance with one embodiment of the present invention.

### DETAILED DESCRIPTION OF INVENTION

The disclosure of the present invention generally provides more detailed descriptions of various concepts related to, and embodiments of, the present invention, methods, and apparatus for a descending-price auction. The concepts introduced above and discussed in greater detail below may be implemented in any of numerous ways, as the disclosed concepts are not limited to any particular manner of implementation. Examples of specific implementations and applications are provided primarily for illustrative purposes.

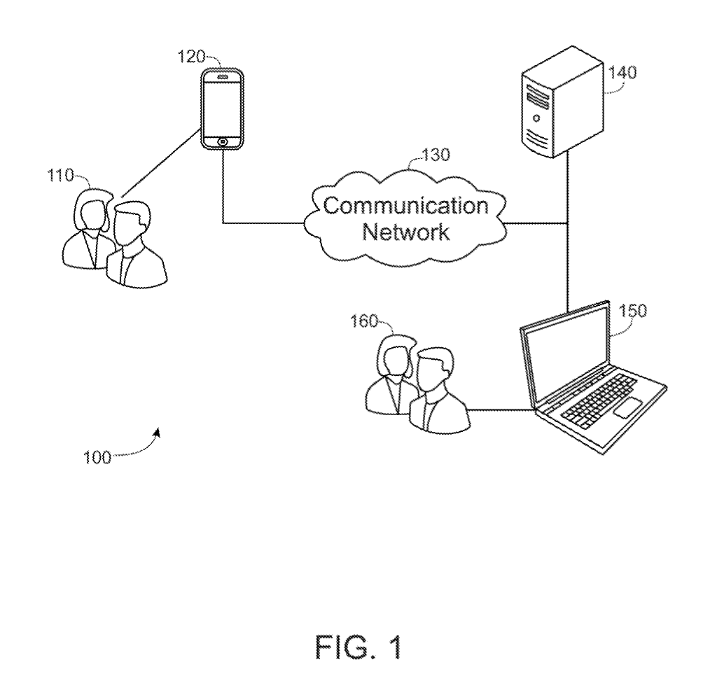

FIG. 1 illustrates a descending-price auction with participating fee system 100 according to an embodiment of the present invention. The system 100 comprises a buyer 110, a buyer communication device 120 such as but not limited to a smartphone, desktop, palmtop or tablet, a communication network 130 such as but not limited to a wired or wireless network, a server 140, a seller communication device 150 and a seller 160 such as but not limited to an auction provider, manufacturer, service provider, dealer or any third party selling a tangible or intangible asset. The seller 160 can manage the auction directly or can procure support through an auction provider. The server 140 communicates with the seller communication device 150 through communication network 130 to allow the seller 160 to communicate auction instructions and to define the auction parameters. The server 140 communicates with a plurality of buyer communication devices 120 through the communication network 130 to display the auction related information such as but not limited to the reserved discount, auction instructions, parameters, starting price, decremental price, auction time or asset information to the buyer 110. In a preferred embodiment of the present invention the buyers may be located at a remote location anywhere in the world connected to the descending-price auction system 100 through the communication network 130. The buyer communication device 120 and the seller communication device 150 such as but not limited to smartphone, tablet, laptop, palmtop, or desktop are connected to communication network 130 through wired or wireless connections.

According to a preferred embodiment of the present invention, the server 140 comprises pre-stored descending-price auction instructions in the server 140 memory and the server 140 processor implements the pre-stored descending-price auction instructions. In alternative embodiments, hardware circuitry may be used in conjunction with or in lieu of software instructions to implement the present disclosure. However, the present disclosure is not limited to any specific combination of hardware circuitry and/or software.

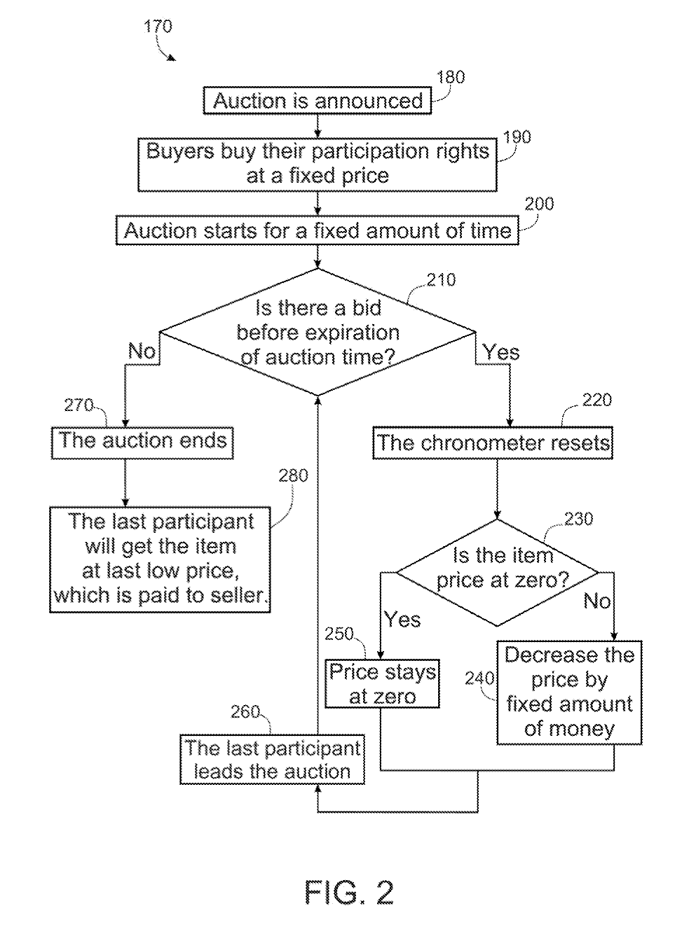

FIG. 2 is a flow diagram illustrating a descending-price auction method 170 according to an embodiment of the present invention. It should be understood that the method 170 shown in FIG. 2 is for illustrative purposes only and that any other suitable method or sub-method could be used in conjunction with or in lieu of method 170 according to an embodiment of the present invention. It should also be understood that the steps of method 170 could be performed in any suitable order or manner.

In a preferred embodiment of the present invention, method 170 starts with step 180 in which the auction is announced and the asset to be auctioned is displayed. The seller or auction provider 160 of an asset may create plurality of initial parameters associated with the auction. The seller or auction provider 160 also defines the fixed amount by which the asset price will be decreased for every new bid used by the prospective buyer 110.

In step 190, the prospective buyers 110 buy their participation rights at a fixed rate which is set by the provider of the auction or by the seller 160. The auction parameters and other instructions defined by the seller or the auction provider 160 are stored in the server 140 memory. In step 200 the auction is initiated and the auction server 140 sets and declares the auction time as defined in the pre-defined instructions of the seller or auction provider 160.

In step 210, the auction server 140 determines whether a bid has been placed within the predefined auction time, and in step 220, the auction server 140 may reset the auction clock for the next bid. The system 100 retrieves the information for resetting the auction time from the auction parameters stored in the server 140 memory regarding the fixed amount of time for the auction. After every new bid is used by the prospective buyer 110, the system 100 edits the amount of time remaining for the current auction to correspond to the initial amount of time. The system 100 updates the information regarding the remaining amount of time through communication network 130 so that the buyer communication devices 120 can show the updated information. The system 100 updates the remaining time for the auction in real time and communicates this remaining time through the communication network 130 as it decreases in real time so that the buyers 110 can always see the accurate remaining time on their buyer communication devices 120. In a preferred embodiment of the present invention, when the set time of the auction has reached zero, the system 100 may put the auction “on hold” for a few seconds before awarding the last buyer 110 with a successful bid within the set time as the final buyer for the auction. This step is to make sure that the server 140 has received any last bid that could have been transmitted on the communication network 130. For example, if a buyer 110 has sent a bid 0.00001 second before the end of time, chances are the server 140 will not have processed this bid on time. In this case, the server 140 would already choose a winning buyer 110 and end the auction prematurely when the auction should have continued. For this reason, the pre-stored instructions on the server 140 of the auction include a decision making instruction that allows the system 100 to wait for a predefined time before giving the instruction to the server 140 to end the auction. If a bid is received during this time, then the auction will continue normally.

In step 230, the auction server 140 determines whether the current price of the asset for sale is zero and if the price is not zero moves to next step 240 in which the server 140 decreases the price by a predefined amount. The whole process as defined in steps 210 to 240 will be repeated until the price reaches zero or there are no further bids for the asset for sale. The system 100 retrieves the information from the auction parameters stored in the server 140 memory regarding the fixed amount that will be decreased from the initial auction price. The system 100 applies the reduction of the fixed amount retrieved to the auction price by editing the current price of the auction that is being stored in the server 140 memory. The system 100 updates the information regarding the actual price of the auction through communication network 130 so that the buyers 110 communication devices 120 can show the updated information to the buyers 110.

In step 250, the server 140, having determined in step 230 that the price has reached zero value, ensures that the price stays at zero for the rest of the auction. In step 260, the server 140 determines that the last participant is leading the auction. In step 270, the server 140, having determined in step 210 that there is no new bidding, ends the auction with the last buyer 110 in the auction, who is deemed the final buyer. In step 280, the server 140 notifies the last buyer 110 that he is the auction leader and has bought the asset for sale at the last low price or at zero price if the price has reached and remained at zero during the auction. In an embodiment, server 140 may notify the winning buyer 110, and/or one or more remote buyers 110 who viewed the asset, by display message, electronic mail message, automated telephone message, instant message, text message, other suitable means, or any combination thereof. The system 100 stores the winner buyer 110 information on the server 140. The system 100 will then communicate with the buyer 110 to share further instructions and information on how the order will be processed. The provider or seller 160 of the auction will have access to this information and will be able to execute the order by any means at its discretion.

In a particularly preferred embodiment of the descending-price auction method and system with participating fee, the method and system of the present invention ensures that the winning buyer 110 will receive at least a predefined discount if the auction ends prematurely. The seller or the auction provider 160 can elect a reserved discount rate that will be guaranteed for the winning buyer 110 by storing this information regarding the auction parameters in the server 140. The system 100 communicates through the network 130 to share this information on the buyers' 110 communication devices 120 so that they know the minimum guaranteed discount. The method and system of the present invention stores the buying history, bidding statistics, and number of actual prospective buyers 110 and offers it to seller or the auction provider 160 so that the seller or auction provider can prepare strategies for other auctions. Some of the information may also be available to buyers 110 as strategic elements. The system 100 monitors all activities, actions and information that are being processed through the network 130 and stores them on the server 140. The information stored on the server 140 comprises the number of prospective bidders on the network, the number of interested buyers checking an asset, the activity of the visitors (active on the network or not), history of participations in the auctions, and the like. The seller or auction provider 160 has access to this information so that it can track the activities and adopt business strategies. The system 100 is also able to analyze this information in order to make real-time smart decisions without assistance from the seller or the auction provider 160. For example, the system 100 is able to automatically start a new auction if it has analyzed that a lot of the buyers 110 on the network 130 could be interested in a specific asset. The system 100 is also able to edit the auction parameters at any time without physical assistance as per the pre-stored instructions on the server 140 memory.

In another embodiment of the present invention, the method and system of the present invention also provides an option to the seller or auction provider 160 of the asset for limiting the number of interested buyers 110 before or during the process of an auction in order to enhance each prospective buyer's 110 opportunity to purchase the asset at a low price without too much competition from other interested buyers 110. In another embodiment of the present invention, the method and system of the present invention provides an option to the seller or auction provider 160 of the asset to limit the buyers 110 as per a geographical limitation set by the seller or auction provider 160 if the seller or auction provider 160 is a service provider operating in a specific geographical area. According to the stats on the buyer 110, the buyer 110 could also be limited in his/her participations in the auctions if, for example, he/she has already been the final buyer of a lot of other assets. These instructions for limiting buyers 110 are pre-defined by the seller or auction provider 160 and are included in the auction parameters which are stored in the server 140. In another embodiment of the present invention, limiting the buyers 110 can be determined manually by the seller or auction provider 160.

The final price of an asset may not be a significant source of revenues in this method of auctions. The revenues for the seller or auction provider 160 of the asset are derived from the participation fees, membership fees or other possible sources of revenues related to the descending-price auction method with participating fee. The server 140 has stored information regarding the participations in an auction so the system 100 is therefore able to analyze this information to define the revenues. The system 100 takes into consideration different criteria to fix the profits for the seller or auction provider 160 such as the analysis of compensation that was offered to the buyers 110 and the revenue margin on the sales, and any other information deemed pertinent. The results can be communicated to the seller and the auction provider 160 through the communication network 130.

Once the system 100 has selected a final buyer 110, it stores this information on the server 140. The system 100 will then communicate with the final buyer 110 through the communication network 130 to send further instructions and information on how to process the payment. The system 100 can also forward the buyer 110 to a third party payment provider in order to complete the payment. The auction provider and the seller 160 will have access to the status of the payment which is stored on the server 140, and will be able to execute the order once the payment is successful. The system 100 is able to send a notification to the seller or the auction provider 160 when there is a change in the status. In another embodiment of the present invention, the system 100 may be able to process the order by itself without needing any assistance from the seller or the auction provider 160. For example, if a gift card is being auctioned, then the system 100 may be able to deliver the gift card to the winning buyer 110 automatically.

It is to be understood that the method and the system described above is not limited to online electronic auctions but is also equally applicable to physical auctions and other mediums.

We claim:

1. A method for descending price auction with participation fee for offering an asset for sale to a plurality of prospective buyers, the method comprising the steps of:
announcing the auction and displaying the asset for sale;
analyzing and creating auction parameters;
selling participation rights to prospective buyers at a pre-defined price;
storing buyer information;
initiating the auction with an initial asset price for a fixed bid time interval defined in the auction parameters within which prospective buyers may place bids;
resetting the bid time interval to its initial value when a bid is placed within the bid time interval;
determining a current asset price reduced from the initial asset price on the basis of the number of bids placed in the auction by prospective buyers and if the current asset price has reached zero then keeping the current asset price at zero;
repeating the above steps of resetting the bid time interval and determining the current asset price whenever a bid is received within the bid time interval;
ending the auction and announcing the last prospective buyer to have placed a bid as the buyer of the asset if there is no bid received within the bid time interval; and
offering a discount or other benefit to the other prospective buyers according to the level of their participation in the auction.

2. The method of claim 1, wherein reducing the asset price is done by a fixed amount defined by the seller or the system before the start of the auction and stored in a server memory.

3. The method of claim 1, wherein a minimum discount offered for the buyer of the asset is defined by the seller or system at the start of the auction and is stored in a server memory.

4. The method of claim 1, wherein the bid time interval is defined by the seller or system before the start of the auction and is stored in a server memory.

5. The method of claim 1, wherein the asset is offered to the buyer at a price of zero currency units if the asset price reaches zero during bidding.

6. The method of claim 1, wherein the fixed bid time interval is displayed on a buyer communication device in real time.

7. The method of claim 1, wherein auction information is displayed on a buyer communication device at all times during the auction.

8. The method of claim 1, wherein what is auctioned is an asset, tangible or intangible, that can be sold using this auction process.

9. The method of claim 1, wherein remaining auction time is displayed on a buyer communication device in real time.

10. A system for descending price auction with participation fee for offering an item to a plurality of buyers, the system comprising:
a buyer communication device;
a communication network;
a server;
a seller communication device;
machine readable instructions stored in the server memory, when executed by one or more processors on a server connected to the communication network to carry out the steps of:
analyzing and creating auction parameters;
selling participation rights at a pre-defined price;
storing buyer information;
initiating the auction with an initial asset price for a fixed bid time interval defined in the auction parameters within which prospective buyers may place bids;
resetting the bid time interval to its initial value as when a bid is placed within the bid time interval;
determining a current asset price reduced from the initial asset price on the basis of the number of bids placed in the auction by prospective buyers and if the current asset price has reached zero then keeping the current asset price at zero;
repeating the above disclosed steps of resetting the bid time interval and determining the current asset price whenever a bid is received within the bid time interval;
ending the auction and announcing the last prospective buyer to have placed a bid as the buyer of the asset if there is no bid received within the bid time interval; and
offering a discount or other benefit to the other prospective buyers according to the level of their participation in the auction.

11. The system of claim 10, wherein the buyer communication device is a smartphone, desktop, palmtop or tablet.

12. The system of claim 10, wherein the seller communication device is a smartphone, desktop, palmtop or tablet.
